(19) United States
(12) Patent Application Publication
(10) Pub. No.: US 2007/0157759 A1
(43) Pub. Date: Jul. 12, 2007

(54) Transport and mounting protection device

(76) Inventor: Fredrik Englund, Trollhattan (SE)

Correspondence Address: HARNESS, DICKEY & PIERCE, P.L.C., P.O. BOX 8910, RESTON, VA, 20195, US

(21) Appl. No.: 11/638,512

(22) Filed: Dec. 14, 2006

(30) Foreign Application Priority Data
Dec. 16, 2005 (SE) 0502816-2

(51) Int. Cl. F16H 57/02

(52) U.S. Cl. 74/606 R

(57) ABSTRACT

A transport and mounting protection device is disclosed, for a shaft passage opening in a housing containing rotary parts, preferably a differential gear housing. The device includes a mounting protection sleeve which is arranged to be inserted, before mounting of a shaft, and maintained in the shaft passage opening and which is arranged to be broken to allow, after mounting of the shaft, the mounting protection sleeve to be removed from the shaft previously inserted through the mounting protection sleeve. The device further includes and a plug element for sealing the shaft passage opening in the absence of a shaft inserted therein. The mounting protection sleeve and said plug element are interconnected by a loop-shaped flexible connection element, which has a length that allows the plug element to be insertable into the mounting protection sleeve by an axial motion relative to the same. A method is further disclosed, of protecting, during mounting, a sealing ring which is mounted in a shaft passage opening of a housing containing rotary parts.

### PRIORITY STATEMENT

The present application hereby claims priority under 35 U.S.C. §119 on Swedish patent application number SE 0502816-2 filed Dec. 16, 2005, the entire contents of which is hereby incorporated herein by reference.

### FIELD

Embodiments of the present invention generally relate to a transport and mounting protection device for a shaft passage opening in a housing containing rotary parts.

### BACKGROUND

Housings of different kinds, for instance transmission housings, are currently handled by various operators on the market. A subcontractor can, for instance, build the transmission housing and test run it, while another company mounts the transmission housing to a driving shaft. When handling a transmission housing, problems may arise, for instance of dirt and dust entering the housing through a driving shaft opening. Furthermore, there may be problems of oil leaking out of the housing through the driving shaft opening, for instance during transport of the housing to an assembly plant, after the test run of the transmission housing has been performed. Today, use is generally made of a cover to seal the opening of the transmission housing during transport and storage. This makes it possible to minimise the risk of oil leakage and of dirt/dust entering the housing.

When a shaft is mounted to a housing, for instance a driving shaft to a transmission housing, a sealing ring is usually arranged to seal between the shaft and the housing so as to prevent oil leakage. The sealing ring can be of different sizes and is mounted in the opening of the transmission housing at an early stage, i.e. usually when the transmission housing is being built. Subsequently, a gearbox arranged in the transmission housing is test run, and before the test run oil is added, which is evacuated after the test run. However, often residual oil remains in the transmission housing.

After the test run of the gearbox and the evacuation of oil, the driving shaft opening is sealed, usually by way of a cover as described above. Later, when the shaft is to be mounted to the transmission housing, the cover is removed so as to make the opening accessible.

When the shaft is being mounted to the housing, for instance in connection with a gearbox being mounted in a vehicle, there is a risk of the shaft damaging the sealing ring while being inserted. This risk is usually minimised by a mounting protector being arranged to protect the sealing ring during the mounting of the shaft. After the removal of the cover from the opening, the mounting protector is usually mounted. The mounting protector is subsequently removed from the sealing ring and the opening of the housing, for instance by an indication of fracture being arranged on the mounting protector.

Today, the mounting protector is provided, for instance, at the assembly line where the shaft is mounted to the transmission housing. The shaft can be mounted without the mounting protector being positioned, but then there is a risk of the sealing ring being damaged. If the sealing ring is damaged, oil may leak out of the gearbox and, if the worst comes to the worst, this may result in the gearbox breaking down when run without enough oil.

Problems arise, for instance, when the mounting protector is not available at the location where the shaft is mounted. The mounting of the shaft is often performed in an assembly line. In that case, it may happen that the fitter, often due to time pressure for instance, does not always bother to stop the assembly line to wait for the protector but mounts the shaft to the housing without the mounting protector. Moreover, there are problems of the mounting protector not always being used by the fitters, even if available, as there is not always a quality control at the line to make sure that the protector is being used. There is also a risk that a fitter will forget to arrange the mounting protector before mounting the shaft.

### SUMMARY

Therefore it is desirable to provide an improved transport protection and mounting protection device.

In an example embodiment of the invention, at least one of the above-mentioned problems is at least partially eliminated. In first aspect of an embodiment of the invention, a transport and mounting protection device is provided for a shaft passage opening in a housing containing rotary parts, preferably a differential gear housing. The device includes a mounting protection sleeve which is arranged to be inserted, before mounting of a shaft, and maintained in the shaft passage opening and which is arranged to be broken to allow, after mounting of the shaft, the mounting protection sleeve to be removed from the shaft previously inserted through said mounting protection sleeve, and a plug element for sealing said shaft passage opening in the absence of a shaft inserted therein. The mounting protection sleeve and the plug element are interconnected by a loop-shaped flexible connection element, which has a length that allows the plug element to be insertable into the mounting protection sleeve by an axial motion relative to the same.

By providing a transport and mounting protection device as defined above, important quality advantages are obtained. Since the mounting protection sleeve and the plug element are interconnected by a loop-shaped flexible connection element, both the mounting protection sleeve and the plug element are applied to the opening of the transmission housing at an early stage of the production process. This can, for instance, already be performed after the test run of the gearbox, before the transport to the assembly plant.

It is therefore ensured that the mounting protection device is positioned when the driving shaft is to be mounted in the opening of the housing, the sealing ring thus being protected, and as a result there is a considerably lower risk of damage to the sealing ring, for instance by the sealing ring being cut up. Consequently, the design of the transport and mounting protection device according to the invention implies a reduced risk of a shaft being mounted without the mounting protection being positioned.

Furthermore, the transport and mounting protection device makes it easier to handle the transmission housing, for instance, during transport and when mounting a shaft in the opening of the housing. This is because the loop-shaped flexible connection element allows the plug element to be easily removable from the mounting protection device since said connection element can also be used as a grip. It is thus easy for the fitter to remove the plug element before the mounting of the shaft by pulling said connection element.

Moreover, a transport and mounting protection device is provided in which said loop-shaped flexible connection element has a length that allows the plug element to be insertable into the mounting protection sleeve by an axial motion relative to the same. As a result, the plug element can have a shape, for instance elongated, which allows it to be reliably maintained in the mounting protection sleeve.

Furthermore, the plug element can be designed so that, when being inserted into the mounting protection sleeve, a supportive effect is obtained on the mounting protection sleeve, which for instance permits the mounting protection sleeve to be designed in a suitable manner with a small material thickness.

According to one embodiment of the invention, the plug element is dimensioned so as to reach through the shaft passage opening of the shaft and into the parts which are adapted to receive the shaft, to guide and center the parts. By providing a transport and mounting protection device according to that stated above, a transport and mounting protection device is obtained which controls the parts included in the gearbox, for instance during the transport of the gearbox.

It is thus ensured that, for instance, vibrations, which may arise during transport, will not displace the parts included in the gearbox. In case of a differential gear, these parts are, for instance, the differential pinion, and it is advantageous to center these parts so that, at a later stage, the shaft will be easily insertable into the transmission housing, for instance without the need of further adjustments.

According to one embodiment of the invention, the portion of said plug element extending, in the active position, through the mounting protection sleeve has an outer diameter which is adapted to be insertable, with a tight fit, into the mounting protection sleeve. Thanks to this design, dirt and dust are prevented from entering the transmission housing when the plug element is inserted into the mounting protection sleeve.

According to one embodiment of the invention, the mounting protection sleeve includes at least one radial projection which, in the active position, is adapted to engage with an inner edge portion of a sealing ring positioned in the shaft passage opening. Owing to this design, the fitter can pull out said plug element from the mounting protection sleeve with a reduced risk of the mounting protection being entrained and thus coming off the transmission housing in an undesirable manner. As a result, it is ensured that the mounting protection is maintained in the shaft opening and protects, in a desired manner, the sealing ring during the insertion of the shaft.

In order to safely engage with the sealing ring, the projection suitably extends along the major part of the periphery of the mounting protection sleeve. According to an alternative embodiment, the projection can be arranged as a plurality of spaced-apart portions which are distributed along the periphery of the mounting protection sleeve.

According to one embodiment of the invention, the radial projection is a flange.

According to a second aspect of an embodiment of the invention, a method is disclosed for protecting, during mounting, a sealing ring which is mounted in a shaft passage opening of a housing containing rotary parts, preferably a differential gear housing. The method comprises:
inserting a mounting protection sleeve and a plug element, before storage and/or transport, into an insertion opening in said sealing ring adapted for the insertion of a shaft,
withdrawing the plug element, on the location of mounting said shaft, from the mounting protection sleeve which is maintained in the shaft passage opening during the insertion of the shaft,
removing the mounting protection sleeve by breaking it off.

### BRIEF DESCRIPTION OF THE DRAWINGS

The invention will now be described in more detail with reference to the example embodiments and accompanying drawings, which for the purpose of exemplification show example embodiments of the present invention.

FIG. 1a is a perspective view of a transport and mounting protection device according to an embodiment of the present invention, with the plug element inserted into the mounting protection sleeve.

FIG. 1b is a perspective view of a transport and mounting protection device according to an embodiment of the present invention, with the plug element withdrawn from the mounting protection sleeve.

FIG. 2 is a perspective view of a transport and mounting protection device according to an embodiment of the present invention in its active position in a differential gear housing.

FIGS. 3a-3e are sequential sectional views of a method, according to an embodiment of the present invention, of protecting a sealing ring during mounting.

### DESCRIPTION OF EXAMPLE EMBODIMENTS

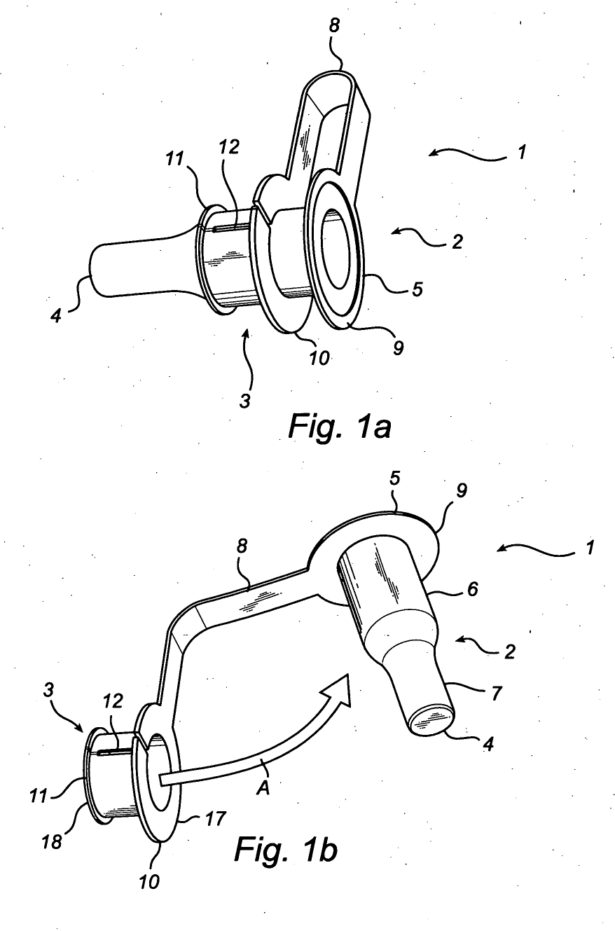

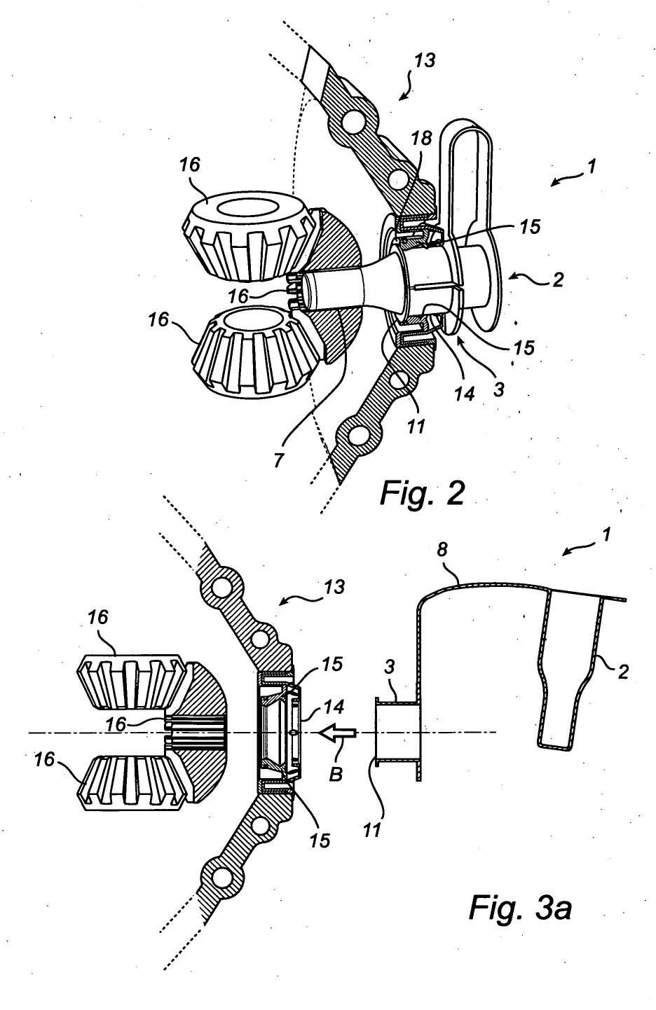

FIGS. 1a-b show a transport and mounting protection device 1 according to an embodiment of the present invention. The transport and mounting protection device 1 is a plug element 2 and a mounting protection sleeve 3 which are interconnected by a coupling element 8. According to the embodiment shown in FIGS. 1a-1b, this coupling element 8 is a loop-shaped flexible connection element. In FIG. 1a, the plug element 2 is inserted into the mounting protection sleeve 3, and in FIG. 1b the plug element 2 is withdrawn from the mounting protection sleeve 3. The arrow A indicates the direction in which the plug element 2 is withdrawn from the mounting protection sleeve 3.

In this example embodiment, the plug element 2 has the form of an elongated hollow cylinder with a distal end 4 and a proximal end 5, seen in the direction of insertion of the plug element 2 into the mounting protection sleeve 3. In this example embodiment, the distal end 4 of the plug element 2 is closed and its proximal end 5 is open.

Furthermore, the plug element 2 has two cylindrical portions 6 and 7 with a cone-shaped transition therebetween. The portion 7 has, in this example embodiment, a substantially smaller outer diameter than the portion 6. The proximal end 5 of the plug element 2 has a radially projecting portion 9, which is connected to the coupling element 8 which has the form of an elongated band. The coupling element 8 suitably has such a length that the entire plug element 2 can be axially withdrawn from the mounting protection sleeve 3, without the plug element 2 being deformed. The other end of the coupling element 8 is connected to the mounting protection sleeve 3.

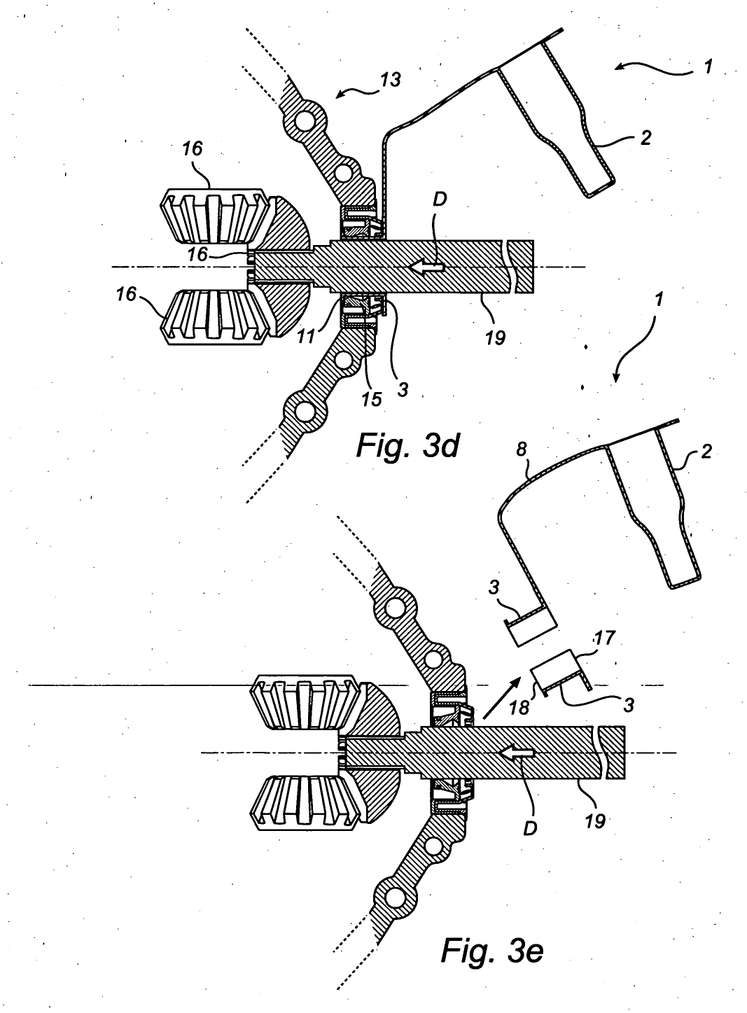

In this example embodiment, the mounting protection sleeve 3 has a substantially circular cross-section with a proximal end 17 and a distal end 18, seen in the direction of insertion B of the mounting protection sleeve 3 (see FIG. 3a). Furthermore, the mounting protection sleeve 3 has a radially projecting portion 10 at its proximal end 17 and a radially projecting portion 11 at its distal end 18. The radially projecting portion 11 is an example of a radial projection according to the embodiment shown in FIGS. 1a-1b.

An indication of fracture 12 extends, according to a example embodiment, from the proximal end 10 along the mounting protection sleeve 3 in the direction of insertion to the distal end 18. The indication of fracture 12 suitably consists of two parts, an elongated slit and a break-off portion, such as an indication of fracture in the material. Suitably, the slit extends along half the length of the mounting protection sleeve 3. The inner diameter of the mounting protection sleeve 3 corresponds to or is greater than the outer diameter of the plug element 2 so that the plug element 2 is insertable into the mounting protection sleeve 3 by an axial motion in the longitudinal direction of the plug element 2.

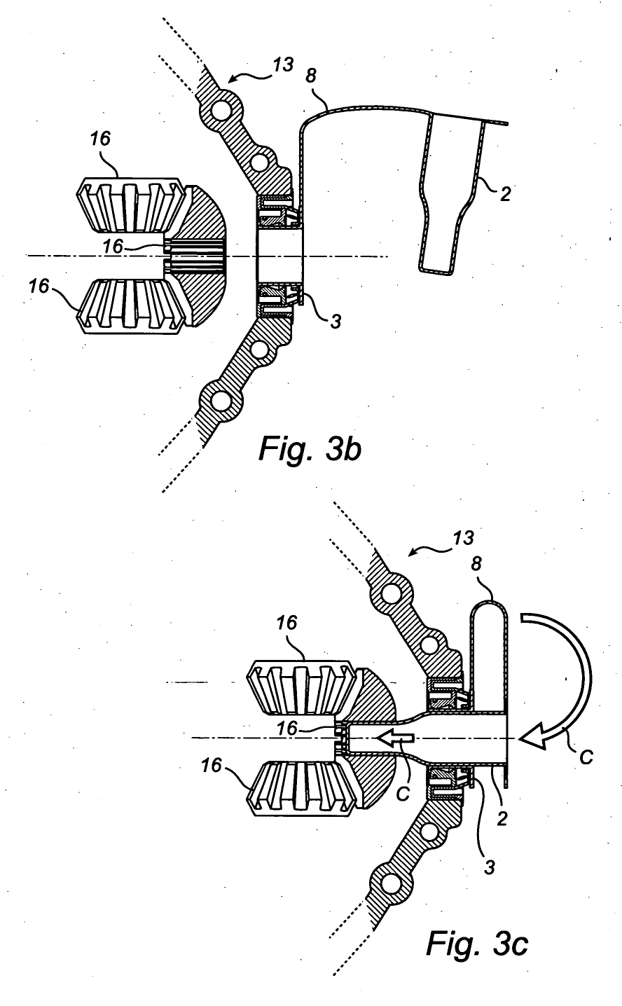

FIG. 2 shows a transport and mounting protection device 1 according to an embodiment of the present invention in its active position in a differential gear housing 13. In the differential gear housing 13, a shaft passage opening 14 is provided, in which a sealing ring 15 is arranged to seal against a shaft 19 which is to be inserted into the shaft passage opening 14. The Figure also shows gear wheels 16 which are arranged in the differential gear housing 13.

The plug element 2 extends through the shaft passage opening 14 into a gear wheel 16 and the portion 7 has a tapered shape adapted to the inner diameter of the gear wheel 16. Owing to this, the plug element 2 centers and guides the gear wheels 16, thus reducing the risk of them being displaced, for instance during the transport of the gearbox.

The projecting portion 11 of the mounting protection sleeve 3 engages with an inner edge portion 18 of the sealing ring 15. As a result, the mounting protection sleeve 3 stays in place in the shaft passage opening 14, also when the plug element 2 is withdrawn from the mounting protection sleeve 3. The radial projecting portion 11 can be optionally positioned in the axial direction, depending on the design of the sealing ring.

FIGS. 3a-3e are sequential views of the mounting of a transport and mounting protection device 1 to a differential gear housing 13 and the sequence of events, for instance after transport of the differential gear housing 13, i.e. the withdrawal of the plug element 2, the insertion of a shaft 19 and the removal of the mounting protection sleeve 3.

FIG. 3a shows a differential gear housing 13 and a transport and mounting protection device 1 before the mounting of the transport and mounting protection device 1 in the shaft passage opening 14. The arrow B in the Figure shows the direction of insertion of the mounting protection sleeve 3 and the plug element 2 into the shaft passage opening 14.

According to this example embodiment, the plug element 2 is not inserted in the mounting protection sleeve 3 when the transport and mounting protection device 1 is to be mounted. However, it will be understood that the mounting protection sleeve can be inserted into the shaft passage opening with the plug element inserted into the mounting protection sleeve.

FIG. 3b shows the mounting protection sleeve 3 when inserted into the shaft passage opening 14.

FIG. 3c shows a transport and mounting protection device 1 when the plug element 2 is inserted into the mounting protection sleeve 3. The arrow C in the Figure indicates the direction of insertion of the plug element 2 into the mounting protection sleeve 3. The plug element 2 extends, as described in FIG. 2, through the mounting protection sleeve 3 and into a gear wheel 16 to guide and center the same. After that, the differential gear housing 13 is ready to be handled, such as transported, for instance, to an assembly plant to be mounted, for instance, in a car (not shown) and connected to a driving shaft 19 in the same.

The plug element 2 acts as a cover of the differential gear housing 13, thus preventing oil leakage and preventing dust and other particles from entering the housing. Furthermore, it is prevented that, for instance, vibrations occurring when handling the differential gear housing 13 displace the gear wheels 16 included in the same.

FIG. 3d shows the situation when the differential gear housing 13 has arrived, for instance, at an assembly plant (not shown) and is positioned to be mounted, for instance, to a driving shaft 19. The plug element 2 is withdrawn from the mounting protection sleeve 3 and a shaft 19 is inserted into the shaft passage opening 14. The arrow D in the Figure indicates the direction of insertion of the shaft 19 into the shaft passage opening 14.

A radially projecting portion 11 of the mounting protection sleeve 3 engages with an inner edge portion of the sealing ring 15. This projecting portion 11 reduces the risk of the mounting protection sleeve 3 being entrained with the plug element 2 when this element is to be removed from the mounting protection sleeve 3. Accordingly, the mounting protection sleeve 3 is maintained in the shaft passage opening, thus protecting the sealing ring 15 during the mounting of the shaft.

FIG. 3e shows a transport and mounting protection device 1 when also the mounting protection sleeve 3 has been removed from the shaft passage opening 14. The fitter can, for instance, grasp the coupling element 8 and/or the plug element 2, which together or individually form a grip for the fitter. By pulling the coupling element 8 and/or the plug element 2, the slit can propagate from the distal end 18 of the mounting protection sleeve 3 all the way along the indication of fracture 12 to its proximal end 17. In this manner, the mounting protection sleeve is broken and can be removed from the shaft 19 in the radial direction.

It will easily be understood that a number of modifications of the preferred embodiment described above are possible within the scope of the invention. In the preferred embodiment, the plug element is in the form of a hollow cylinder, but it may also be solid.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A transport and mounting protection device for a shaft passage opening in a housing containing rotary parts, comprising:
a mounting protection sleeve, arranged to be inserted, before mounting of a shaft, and maintained in said shaft passage opening and arranged to be broken to allow, after mounting of the shaft, said mounting protection sleeve to be removed from the shaft previously inserted through said mounting protection sleeve; and
a plug element to seal said shaft passage opening in the absence of a shaft inserted therein, said mounting protection sleeve and said plug element being interconnected by a loop-shaped flexible connection element including a length that allows the plug element to be insertable into the mounting protection sleeve by an axial motion relative to the same.

2. A transport and mounting protection device as claimed in claim 1, wherein said plug element is dimensioned so as to reach through the shaft passage opening of the shaft and into the parts which are adapted to receive said shaft, to guide and center said parts.

3. A transport and mounting protection device as claimed in claim 1, wherein the portion of the plug element extending, in the active position, through the mounting protection sleeve includes an outer diameter which is adapted to be insertable, with a tight fit, into the mounting protection sleeve.

4. A transport and mounting protection device as claimed in claim 1, wherein the mounting protection sleeve comprises at least one radial projection which, in the active position, is adapted to engage with an inner edge portion of a sealing ring positioned in the shaft passage opening.

5. A transport and mounting protection device as claimed in claim 4, wherein said projection extends along the major part of the periphery of the mounting protection sleeve.

6. A transport and mounting protection device as claimed in claim 4, wherein said radial projection is a flange.

7. A method of protecting, during mounting, a sealing ring mounted in a shaft passage opening of a housing containing rotary parts, said method comprising:
inserting a mounting protection sleeve and a plug element, before at least one of storage and transport, into an insertion opening in said sealing ring adapted for the insertion of a shaft;
withdrawing the plug element, on the location of mounting said shaft, from the mounting protection sleeve which is maintained in the shaft passage opening during the insertion of the shaft; and
removing the mounting protection sleeve by breaking it off.

8. A transport and mounting protection device as claimed in claim 1, wherein the housing containing rotary parts is a differential gear housing.

9. A transport and mounting protection device as claimed in claim 2, wherein the portion of the plug element extending, in the active position, through the mounting protection sleeve includes an outer diameter which is adapted to be insertable, with a tight fit, into the mounting protection sleeve.

10. A transport and mounting protection device as claimed in claim 2, wherein the mounting protection sleeve comprises at least one radial projection which, in the active position, is adapted to engage with an inner edge portion of a sealing ring positioned in the shaft passage opening.

11. A transport and mounting protection device as claimed in claim 3, wherein the mounting protection sleeve comprises at least one radial projection which, in the active position, is adapted to engage with an inner edge portion of a sealing ring positioned in the shaft passage opening.

12. A transport and mounting protection device as claimed in claim 5, wherein said radial projection is a flange.

13. A method of protecting as claimed in claim 7, wherein the housing containing rotary parts is a differential gear housing.
